(19) United States
(12) Patent Application Publication
(10) Pub. No.: US 2024/0086615 A1
(43) Pub. Date: Mar. 14, 2024

(54) ON-BOARD DEVICE AND SYSTEM FOR VEHICLE

(71) Applicant: DENSO CORPORATION, Kariya-city (JP)

(72) Inventors: Asahi KONDO, Kariya-city (JP); Kiyohiko SAWADA, Kariya-city (JP)

(21) Appl. No.: 18/516,797

(22) Filed: Nov. 21, 2023

Related U.S. Application Data
(63) Continuation of application No. PCT/JP2022/020659, filed on May 18, 2022.

(30) Foreign Application Priority Data
May 24, 2021 (JP) 2021-086978

(51) Int. Cl. G06F 40/106

(52) U.S. Cl. CPC G06F 40/106

(57) ABSTRACT

An on-board device for a vehicle, includes a storage unit and a display processing unit. The storage unit is configured to store display information that is information for displaying certification information required to be displayed pursuant to laws and regulations on a display device. The display processing unit is configured to perform a process for displaying the certification information on an on-board display device that is the display device on-board the vehicle, using the display information stored in the storage unit.

### CROSS-REFERENCE TO RELATED APPLICATION

This application is a continuation application of International Application No. PCT/JP2022/020659 filed May 18, 2022 which designated the U.S. and claims priority to Japanese Patent Application No. 2021-086978 filed with the Japan Patent Office on May 24, 2021, the contents of each of which are incorporated herein by reference.

### BACKGROUND

### Technical Field

This disclosure relates to on-board devices for vehicles.

### Related Art

Products are known that are legally required to display information to certify that they conform to technical standards defined by laws and regulations. For example, certification information required by laws and regulations to be displayed includes the Technical Conformity Mark that is required by the Japanese radiocommunications law to be displayed.

The radiocommunications law requires the Technical Conformity Mark to be displayed on products that use radio waves, such as cellular phones. Therefore, for these types of products, the Technical Conformity Mark is displayed on their bodies.

However, there is an issue that small-sized products have difficulty in securing space for displaying the Technical Conformity Mark on their bodies.

The website of the Ministry of Internal Affairs and Communications states that it is acceptable to display the Technical Conformity Mark on an external display instead of displaying the Technical Conformity Mark on the product body (see How to display the Technical Conformity Mark, [online], Ministry of Internal Affairs and Communications, [retrieved on Feb. 4, 2021], URL: https://www.tele.soumu.go.jp/j/sys/equ/tech/gitekimark/index.htm).

In this regard, on-board devices for vehicles such as automobiles that use radio waves, such as millimeter-wave radar devices, are subject to the radiocommunications law. Therefore, on-board devices of this type have the Technical Conformity Mark displayed on their bodies.

However, as a result of detailed research that was performed by the present inventors, an issue was found that, as on-board devices are downsized, it may become difficult to secure space for displaying the Technical Conformity Mark on their bodies in the future. Such an issue is not specific to on-board devices subject to the radiocommunications law, but can also arise for on-board devices subject to other laws and regulations that require certification information to be displayed.

In view of the foregoing, it is desired to have a novel technique for displaying certification information for on-board devices.

One aspect of the present disclosure provides an on-board device for a vehicle, including a storage unit and a display processing unit. The storage unit is configured to store display information that is information for displaying certification information required to be displayed pursuant to laws and regulations on a display device. The display processing unit is configured to perform a process for displaying the certification information on an on-board display device that is the display device on-board the vehicle, using the display information stored in the storage unit.

This configuration allows the certification information of the on-board device to be displayed on the on-board display device.

### BRIEF DESCRIPTION OF THE DRAWINGS

In the accompanying drawings:

FIG. 1A is a block diagram illustrating a configuration of an on-board system for a vehicle;

FIG. 1B is a functional block diagram of a sensor-side processing unit of a millimeter-wave radar sensor;

FIG. 1C illustrating a functional block diagram of an HMI-side processing unit of an HMI processing device;

FIG. 2 is a block diagram illustrating a configuration of a millimeter-wave radar sensor connected to an external display device;

FIG. 3 is a flowchart of a certification display process performed with the millimeter-wave radar sensor;

FIG. 4 is an illustration of contents of display information database; and

FIG. 5 is a flowchart of a request determination process performed by an HMI processing device.

### DESCRIPTION OF SPECIFIC EMBODIMENTS

Hereinafter, some exemplary embodiments of the disclosure will be described with reference to the accompanying drawings.

### 1. Configuration

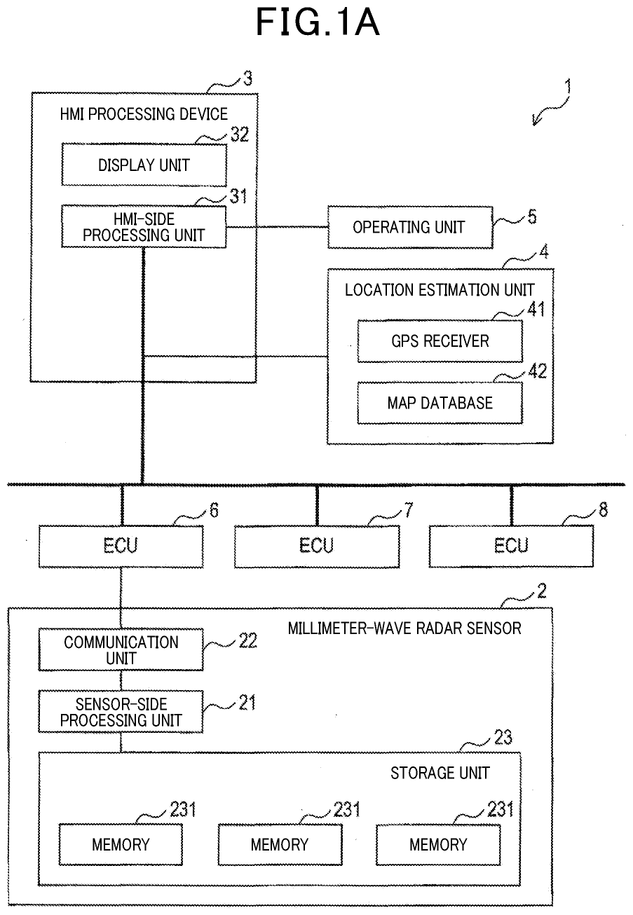

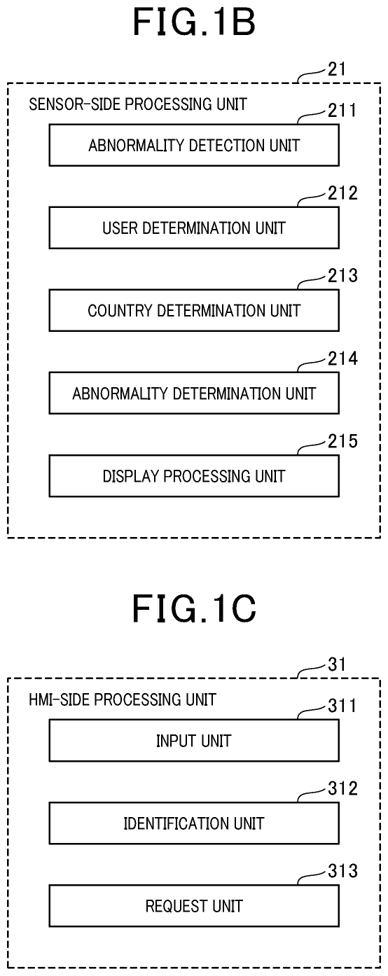

The on-board system 1 illustrated in FIG. 1A is mounted to a vehicle. The on-board system 1 has a function to display certification information of the millimeter-wave radar sensor 2 on an on-board display device that is a display device mounted to the vehicle. The certification information is information that is required by laws and regulations to be displayed.

Since the millimeter-wave radar sensor 2 is a product that uses radio waves, it is mandatory according to the radiocommunications law to display the certification information on the millimeter-wave radar sensor 2. Therefore, the millimeter-wave radar sensor 2 is configured to be capable of displaying certification information on the on-board display device as information certifying that it complies with the technical standards specified by the radiocommunications law and is licensed for use of radio waves.

The on-board system 1 includes the millimeter-wave radar sensor 2, an HMI processing device 3, a location estimation unit 4, and an operating unit 5. The millimeter-wave radar sensor 2 is connected to an ECU 6 and is configured to communicate with the HMI processing device 3 via the ECU 6.

Specifically, in the vehicle of the present embodiment, a plurality of ECUs 6-8, including the ECU 6 to which the millimeter-wave radar sensor 2 is connected, and the HMI processing device 3 are communicably connected via an on-board network, such as CAN. The millimeter-wave radar sensor 2 may be configured to communicate directly with the HMI processing device 3 via no ECUs.

HMI is an abbreviation for Human Machine Interface. CAN is an abbreviation for Controller Area Network, which is a registered trademark. ECU is an abbreviation for Electronic Control Unit.

The millimeter-wave radar sensor 2 is a sensor for detecting objects around the vehicle by transmitting and receiving radio waves in the millimeter-wave band. The millimeter-wave radar sensor 2 includes a sensor-side processing unit 21, a communication unit 22, and a storage unit 23.

The sensor-side processing unit 21 is mainly configured as a well-known microcomputer including a CPU, a ROM, a RAM, and other components, which are not shown. The CPU executes a program that is stored in a non-transitory tangible storage medium, such as the ROM. When said program is executed, a method corresponding to said program is implemented.

In the present embodiment, display software, which is a program for causing the sensor-side processing unit 21 to perform a certification display process described later, is stored in the storage unit 23 described later. The sensor-side processing unit 21 may include a single microcomputer or a plurality of microcomputers.

The method of implementing the functions of the sensor-side processing unit 21 is not limited to software, but some or all of the functions of the sensor-side processing unit 21 may be implemented using one or plurality of pieces of hardware.

For example, in cases where the above functions are implemented by electronic circuits as hardware, the electronic circuits may be implemented by digital or analog circuits, or a combination of both types of circuits.

The communication unit 22 is configured to be wired to an external device, specifically, the ECU 6 or an external display device, thereby enabling communication between the external device and the sensor-side processing unit 21.

The storage unit 23 includes a plurality of memories 231. In the present embodiment, the storage unit 23 includes three memories 231. The memories 231 store a display information database described later. As described above, the display software is stored in the storage unit 23.

The HMI processing device 3 includes an HMI-side processing unit 31 and a display unit 32.

The HMI-side processing unit 31 is mainly configured as a well-known microcomputer including a CPU, a ROM, a RAM, and other components, which are not shown. The CPU executes a program stored in a non-transitory tangible storage medium, such as the ROM. When said program is executed, the method corresponding to said program is implemented.

In the present embodiment, a program for causing the HMI-side processing unit 31 to perform a request determination process as described later is stored therein. The HMI-side processing unit 31 may include one microcomputer or a plurality of microcomputers.

The method of implementing the functions of the HMI-side processing unit 31 is not limited to software, but some or all of the functions may be implemented using one or a plurality of pieces of hardware. For example, in cases where the above functions are implemented by electronic circuits as hardware, the electronic circuits may be implemented by digital or analog circuits, or a combination of both types of circuits.

The display unit 32 is an on-board display device installed in a cabin of a vehicle. In the present embodiment, the display unit 32 is a display capable of displaying map images for navigation and other information.

The location estimation unit 4 is configured to estimate the current location of the vehicle. The location estimation unit 4 includes a GPS receiver 41 and a map database 42.

The location estimation unit 4 includes a GPS receiver 41 and a map database 42. GPS is an abbreviation for Global Positioning System.

The map database 42 is a database configured to store map data.

The operating unit 5 is configured to receive operations from a user in the vehicle. The user's operations include, for example, a display request operation, which is an operation requesting certification information to be displayed. In the present embodiment, the operating unit 5 is a push button installed on the steering wheel of the vehicle.

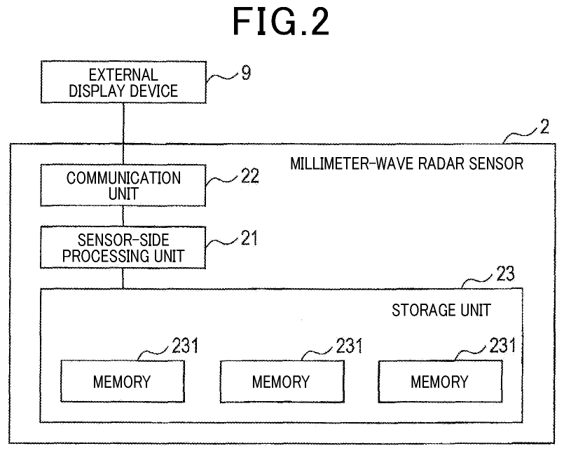

In an on-board state where the millimeter-wave radar sensor 2 is incorporated in the on-board system 1 as illustrated in FIG. 1A, the millimeter-wave radar sensor 2 causes certification information to be displayed on the display unit 32 as an on-board display device. Besides, the millimeter-wave radar sensor 2 may also cause the certification information to be displayed on an external display device 9 that is in communication with the millimeter-wave radar sensor 2, even in a stand-alone state, that is, in a state where the millimeter-wave radar sensor 2 is not mounted to the vehicle and thus not incorporated in the on-board system 1, as illustrated in FIG. 2.

In the present embodiment, the millimeter-wave radar sensor 2 is configured to be in wired communication with the external display device 9 via a cable. For example, a personal computer equipped with a display is used as the external display device 9.

### 2. Overview of Certification Display Process

Next, an overview of the certification display process performed by the sensor-side display unit 21 of the millimeter-wave radar sensor 2 will now be described. The certification display process is a process for displaying certification information on a display device. In the present embodiment, the certification display process is performed to display the certification information on the display unit 32 as the on-board display device or on the external display device 9.

The millimeter-wave radar sensor 2 is configured to perform the process for displaying the certification information on the display device in two different display modes in accordance with the type of user, that is, according to whether the user attempting to visually check the certification information is a general user or a professional user.

The general user is assumed to be a user who does not have expert knowledge about certification information. For example, an occupant of the vehicle equipped with the millimeter-wave radar sensor 2 is considered to be a general user.

On the other hand, the professional user is assumed to be a user who has more professional knowledge about certification information than the general user. For example, a person who belongs to a management organization that manages the operation of certification information, such as whether certification information is legally displayed on products that are required to display certification information, or a person who belongs to a manufacturer of the millimeter-wave radar sensor 2 are considered to be a professional user.

In the display mode for general users, certification information is displayed on the display device. In the display mode for professional users, supplementary information is displayed on the display device along with the certification information. The supplementary information is information for professional users about the certification information, and is not displayed in the display mode for general users. The supplementary information is information that is not required to be displayed by laws and regulations, specifically the radiocommunications law, but is used to determine whether the certification information is legally displayed on the display device.

The state in which certification information is legally displayed means, for example, that the certification information is displayed in a manner that meets display requirements based on laws and regulations, such as display contents and display dimensions. In other words, in the display mode for general users, a minimum amount of information that is required to be displayed by laws and regulations is displayed on the display device. By contrast, in the display mode for professional users, information to confirm the legality of the certification information being displayed is also displayed on the display device.

This is because the purpose of viewing certification information may differ between general users and professional users. For example, for general users, it may be sufficient to confirm that the millimeter-wave radar sensor 2 is a product that complies with the technical standard specified by laws and regulations. On the other hand, for professional users, it may also be necessary to confirm that the certification information is legally displayed.

The millimeter-wave radar sensor 2 of the present embodiment is configured to perform a process to display the certification information on the display device in a plurality of display modes pursuant to laws and regulations of a plurality of countries. This is because it is assumed that the millimeter-wave radar sensor 2 is used in a plurality of countries, but the display mode pursuant to the laws and regulations that require display of certification information may differ from country to country.

### 3. Sensor-Side Process

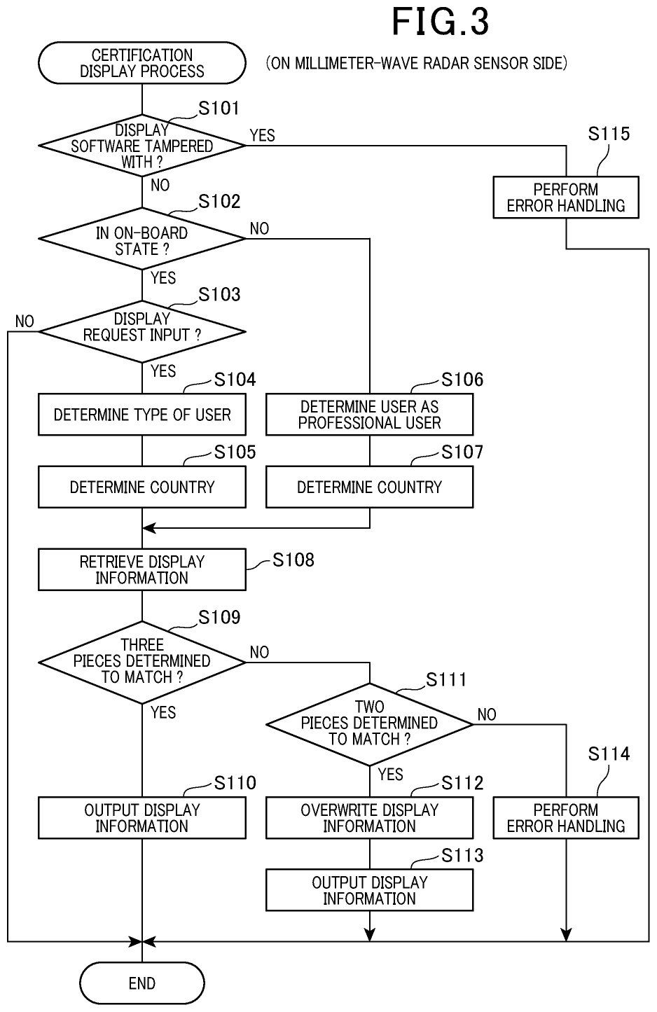

Next, the certification display process performed by the sensor-side processing unit 21 of the millimeter-wave radar sensor 2 will now be described using the flowchart in FIG. 3.

The sensor-side processing unit 21 performs the certification display process illustrated in FIG. 3 at predefined time intervals while the millimeter-wave radar sensor 2 is being supplied with electric power. The millimeter-wave radar sensor 2 is powered by the vehicle's battery in the on-board state, and is powered by the external display device 9 when the millimeter-wave radar sensor 2 is wired to the external display device 9 in the stand-alone state.

First, at S101, the sensor-side processing unit 21 detects whether the display software has been tampered with. In the present embodiment, the sensor-side processing unit 21 determines whether the display software has been tampered with by comparing the hash value of the display software in its normal state stored in advance with the hash value calculated from the display software at the present time.

Specifically, if both hash values match, it is determined that the display software has not been tampered with. If both hash values do not match, it is determined that the display software has been tampered with.

If the sensor-side processing unit 21 determines that the display software has not been tampered with, the routine proceeds to S102.

At S102, the sensor-side processing unit 21 determines whether the millimeter-wave radar sensor 2 is in the on-board state. In the present embodiment, the millimeter-wave radar sensor 2 is determined to be in the on-board state when the millimeter-wave radar sensor 2 is detected as being connected to the ECU 6. If the sensor-side processing unit 21 determines that the millimeter-wave radar sensor 2 is in the on-board state at S102, the routine proceeds to S103.

At S103, the sensor-side processing unit 21 determines whether a display request has been input from the HMI processing device 3. A display request is a request to perform a process for displaying certification information on the display unit 32 as an on-board display device in a display mode in accordance with an instruction from the user. The display request includes user information indicating the type of user determined by the HMI processing device 3 as attempting to view the certification information, and country information indicating the country corresponding to current location of the vehicle.

In what cases the display request is to be input to the sensor-side processing unit 21 will be described later in the request determination process. If the sensor-side processing unit 21 determines that no display request has been input from the HMI processing device 3 at S103, the certification display process illustrated in FIG. 3 then ends.

If the sensor-side processing unit 21 determines that a display request has been input from the HMI processing device 3 at S103, the routine proceeds to S104.

At S104, the sensor-side processing unit 21 determines the type of user based on the user information included in the display request.

Then, at S105, the sensor-side processing unit 21 determines the country in which the millimeter-wave radar sensor 2 is used (referred to as a country of use) based on the country information included in the display request, and then the routine proceeds to S108.

On the other hand, if the sensor-side processing unit 21 determines at S102 that the millimeter-wave radar sensor 2 is not on-board, that is, that the millimeter-wave radar sensor 2 is connected to the external display device 9 in the stand-alone state and capable of communicating with the external display device 9, the routine proceeds to S106.

At S106, the sensor-side processing unit 21 determines that the type of user is the professional user.

Then, at S107, the sensor-side processor 21 determines the country of use. In the present embodiment, it is assumed that the user enters information indicating the country of use via the external display device 9 when the millimeter-wave radar sensor 2 is communicably connected to the external display device 9 in the stand-alone state. After the sensor-side processing unit 21 determines the country of use based on the information entered by the user, the routine proceeds to S108.

At S108, the sensor-side processing unit 21 retrieves display information from the display information database stored in the storage unit 23. The display information is information for displaying certification information or the like on a display device, and in the present embodiment, it is image information representing a display image. The display information database is a database for managing a plurality of types of display information.

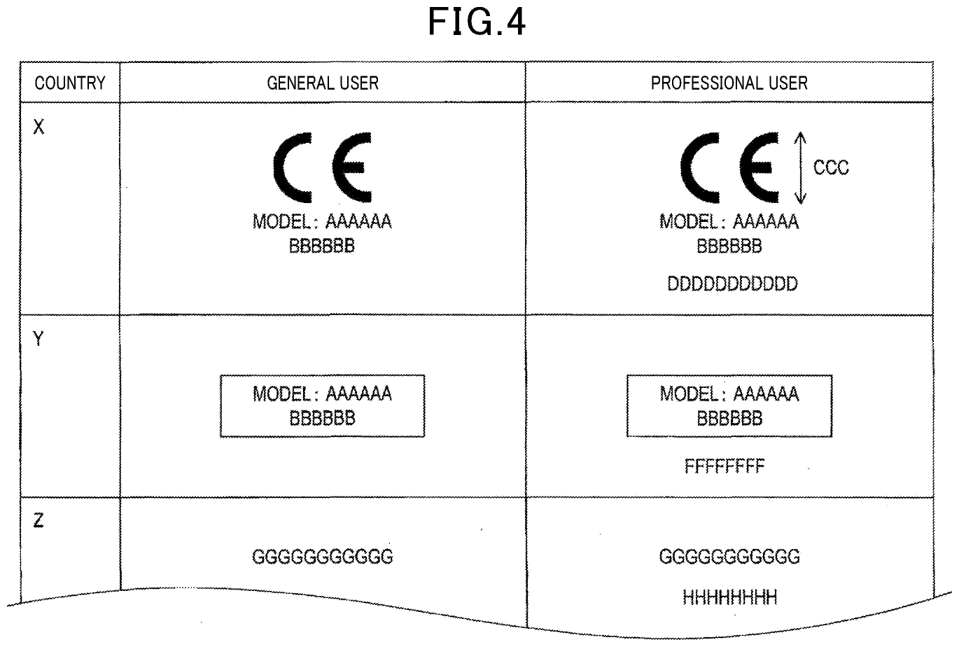

In the present embodiment, as illustrated in FIG. 4, a plurality of types of display information corresponding to respective types of users and a plurality of countries are managed in the display information database. The display information corresponding to the respective types of users includes the display information to be displayed on the display device in the display mode for general users, or the display information to be displayed on the display device in the display mode for professional users.

The display information corresponding to a certain country refers to the display information to be displayed on the display device in the display mode pursuant to the laws and regulations of that country.

The details of the display information will now be described using FIG. 4. In this example, there are exemplarily shown, among a plurality of countries where the display information is managed in the display information database, a plurality of countries whose display modes are different according to the laws and regulations that require display of the certification information.

First, as an example where the certification information includes a certification mark, the display information corresponding to a country X will now be described. The certification mark is a mark to certify that a product conforms to the technical standard specified by laws and regulations and is licensed for use of radio waves. For example, the Technical Conformity Mark and the CE Mark are known as certification marks.

The certification mark in the country X is the CE mark. In the example of Country X, the display information corresponding to the general users represents only the certification information. The certification information consists of the certification mark “CE”, the model of the millimeter-wave radar sensor 2 “MODEL: AAAAAAAA”, and the manufacturer's name of the millimeter-wave radar sensor 2 “BBBBB”. However, in FIG. 4, the sequence of identical alphabetic characters means hidden letters.

On the other hand, the display information corresponding to the professional users represents supplementary information in addition to the certification information. The supplementary information consists of the display size of the certification mark “CCC”, and information on the display requirements for the display size of the certification mark “DD . . . DD”. The information regarding the display requirements for the display size of the certification mark includes the basis on which the certification mark displayed on the display device meets the display requirements.

For example, the following explanatory text “The dimension of the certification mark is CCC. The display size requirement is that it is EEE or greater, which is met.” or other information may be displayed at the position of the series of Ds. That is, the supplementary information in the example of Country Xis information for determining that the certification mark meets the display size requirement and is legitimately displayed.

In some cases, it is mandatory that the certification mark be displayed in the owner's manual or the like, in addition to displaying the certification mark on the product. In such cases, for example, in addition to the above explanatory text, the following explanatory text “The certification mark is printed in the manual in the size you see.” or other information may be displayed at the position of the series of Ds. In this manner, it will be easier for the user to determine whether the requirement for displaying certification information in the manual is met.

Next, display information corresponding to Country Y will now be described as an example where the law has been revised in recent years and the requirements for displaying certification information have been changed according to the revision. In the example of Country Y, the display information corresponding to the general users represents only the certification information, and the certification information consists of the model of the millimeter-wave radar sensor 2 “MODEL: AAAAAAAA” and the manufacturer's name of the millimeter-wave radar sensor 2 “BBBBB.

On the other hand, the display information corresponding to the professional users represents supplementary information in addition to the certification information. The supplementary information is the information “FF . . . FF” regarding the revision of laws and regulations. The information regarding the revision of the laws and regulations includes information indicating whether the product was licensed before or after the revision of the laws and regulations, that is, whether the product's certification information is displayed in accordance with the display requirements of the old laws and regulations or the new laws and regulations.

For example, the following explanatory text “This product was licensed as of January 1, 20XX, thus this certification information is displayed based on the new laws and regulations.” or other information may be displayed at the position of the series of Fs. That is, in countries where laws and regulations have been revised in recent years, the requirements for displaying certification information are changed pursuant to the revised laws and regulations, which may lead to a situation where both products displaying certification information based on the old laws and regulations and products displaying certification information based on the new laws and regulations are in circulation.

The supplementary information in the example of Country Y is information for determining that the certification information is legally displayed according to when the license was acquired in cases where the display requirements for certification information have been changed pursuant to revisions to the laws and regulations.

Next, display information corresponding to Country Z will now be described as an example where display of certification information is not required by laws and regulations. In the example of Country Z, the display information corresponding to the general users represents only notification information “GG . . . GG”, which notifies that the product complies with the technical standard specified by the laws and regulations. The notification information is simple because it is not information that is required by laws and regulations to be displayed.

For example, the following explanatory text “No certification information is available. This product is licensed under the radiocommunications law in Country Z.” or other information may be displayed at the position of the series of Gs. That is, the notification information is used in place of certification information to determine whether the product complies with the technical standard specified by the laws and regulations in countries where the display of certification information is not required.

On the other hand, the display information corresponding to professional users represents supplemental information in addition to the notification information. The supplementary information represents the information “HEI . . . HEI”, which indicates the reason for lack of display of certification information. The information indicating the reason for the lack of display of certification information includes information indicating whether there are laws or regulations that require the display of certification information. For example, the following explanatory text “No certification information is displayed, as it is not mandatory in Country Z to display such information.” or other information may be displayed at the position of the series of Hs.

That is, the supplemental information in the example of Country Z is information for determining that lack of display of certification information is not illegal in countries where such certification information is not required to be displayed. In the present embodiment, the same display information database is redundantly stored in each of the three memories 231 of the storage unit 23. The sensor-side processing unit 21 retrieves from each of the three display information databases display information corresponding to the type of user and country determined at S104 and S105 or S106 and S107.

Then, at S109, the sensor-side processing unit 21 determines whether the three pieces of display information retrieved at S108 match. In the present embodiment, the sensor-side processing unit 21 compares contents of the three pieces of display information with each other, and determines that the three pieces of display information match if no differences are detected. If the sensor-side processing unit 21 determines that the three pieces of display information match, the routine proceeds to S110.

At S110, the sensor-side processing unit 21 outputs one of the three pieces of display information retrieved at S108 to the display device.

In the certification display process illustrated in FIG. 3, the display device to which the sensor-side processing unit 21 outputs the display information and error information described later is the display unit 32 in the case where the millimeter-wave radar sensor 2 is in the on-board state, i.e., the determination at S102 is YES. The display device in the case where the millimeter-wave radar sensor 2 is in the stand-alone state, i.e., the determination at S102 is NO, is the external display device 9. The sensor-side processing unit 21 then terminates the certification display process illustrated in FIG. 3.

On the other hand, if the sensor-side processing unit 21 determines at S109 that at least one of the three pieces of display information retrieved at S108 does not match, the routine proceeds to S111.

At S111, the sensor-side processing unit 21 determines whether two of the three pieces of display information retrieved at S108 match. At S111, if the sensor-side processing unit 21 determines that two of the three pieces of display information retrieved at S108 match, the routine proceeds to S112.

At S112, the sensor-side processing unit 21 overwrites the remaining one piece of display information that was determined not to match with one of the two pieces of display information determined to match at S111.

Then, at S113, the sensor-side processing unit 21 outputs one of the two pieces of display information determined to match at S111 to the display device. The sensor-side processing unit 21 then terminates the certification display process illustrated in FIG. 3.

On the other hand, if the sensor-side processing unit 21 determines at S111 that none of the three pieces of information for display retrieved at S108 mutually match, the process routinely proceeds to S114.

At S114, the sensor-side processing unit 21 performs error handling. In the present embodiment, the sensor-side processing unit 21 performs the error handling at S114, where the sensor-side processing unit 21 outputs image information for displaying an error message to the display device as error information. The error message is a message that notifies the user that the certification information is not displayed. The sensor-side processing unit 21 then terminates the certification display process illustrated in FIG. 3.

As described above, in the present embodiment, error handling is performed when at least one of the three pieces of display information stored redundantly is determined not to match. This is because the contents of at least one of the three pieces of display information are considered to have been changed due to being tampered with or damaged.

Changes in contents of the display information include changes in values of the display information and vanishing of values themselves. That is, an abnormality in the display information is determined by comparing the same display information stored redundantly with each other. However, if two of the three pieces of display information match, it is likely that the contents of those two pieces of display information have not changed.

Thus, in this case, error handling is not performed exceptionally, and the remaining one piece of display information is overwritten with one of the two pieces of display information. That is, identifying the display information whose contents are likely to remain unchanged and overwriting the remaining display information with the display information whose contents are likely to remain unchanged, allows the process for displaying certification information to continue without error handling being performed.

On the other hand, if the sensor-side processing unit 21 determines that the display software has been tampered with at S101, the routine proceeds to S115.

At S115, the sensor-side processing unit 21 performs error handling. In the present embodiment, the sensor-side processing unit 21 performs, as error handling at S115, a process of outputting to the display device image information for displaying a confirmation message as error information. The confirmation message is a message that prompts the user to check the status of the display software.

This is because if the certification display process is implemented by tampered display information software, incorrect certification information may be displayed. The sensor-side processing unit 21 then terminates the certification display process illustrated in FIG. 3.

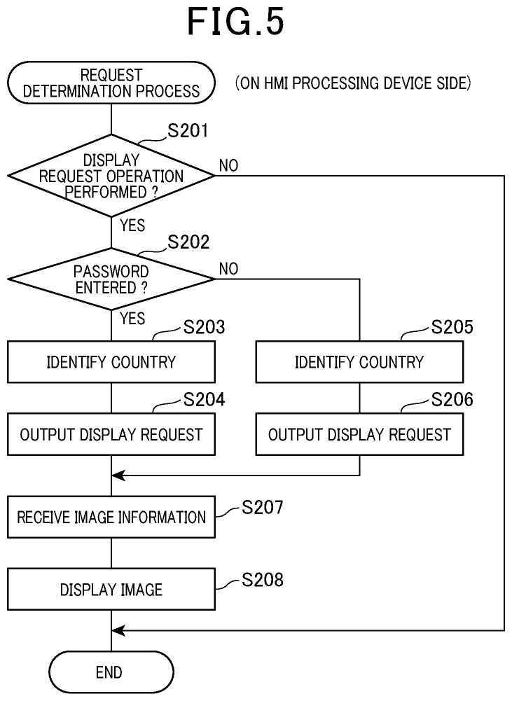

Next, the request determination process performed by the HMI-side processing unit 31 of the HMI processing device 3 will now be described with reference to the flowchart illustrated in FIG. 5. The HMI-side processing unit 31 performs the request determination process illustrated in FIG. 5 at predefined time intervals while the vehicle's accessory switch is ON.

First, at S201, the HMI-side processing unit 31 determines whether the above-described display request operation has been performed by a user in the vehicle. In the present embodiment, upon receipt of the display request operation via the operating unit 5, the HMI-side processing unit 31 determines that the display request operation has been performed by a user in the vehicle.

In other words, it is determined whether the user riding in the vehicle is attempting to view the certification information on the display unit 32. If the HMI-side processing unit 31 determines that the display request operating unit has not been performed by the user, the request determination process illustrated in FIG. 5 ends. On the other hand, if the HMI-side processing unit 31 determines that the display request operation has been performed by the user, the routine proceeds to S202.

At S202, the HMI-side processing unit 31 determines whether a password has been entered by the user via the operating unit 5. Specifically, a password is determined to have been entered when the password entered by the user matches the pre-set password for identifying the professional users.

This password is information known only to the professional users. Therefore, a determination that the password has been entered leads to a determination that the type of user who is attempting to view the certification information is a professional user. A determination that the password has not been entered leads to a determination that the type of user who is attempting to view the certification information is a general user.

That is, the presence or absence of the password entered represents an indication from the user indicating whether the type of user who is attempting to view the certification information on the display unit 32 is a general user or a professional user.

In this manner, users attempting to view the certification information on the display unit 32 are assumed to include general users and professional users. Therefore, in the certification display process illustrated in FIG. 3, in the case where it is determined at S102 that the millimeter-wave radar sensor 2 is in the on-board state, it is determined at S104 that the type of user is either a general user or a professional user.

On the other hand, users attempting to view the certification information on the external display device 9 are assumed to be professional users only. Therefore, in the certification display process illustrated in FIG. 3, a determination at S102 that the millimeter-wave radar sensor 2 is in the stand-alone state and communicably connected to the external display device 9 leads to a determination at S106 that the type of user is a professional user.

If the HMI-side processing unit 31 determines that the password has been entered by the user via the operating unit 5 at S202, the routine proceeds to S203.

At S203, the HMI-side processing unit 31 identifies the country corresponding to the current position of the vehicle. In the present embodiment, the HMI-side processing unit 31 identifies the country corresponding to the current location of the vehicle based on the GPS signals received by the GPS receiver 41 of the location estimation unit 4 and the map data stored by the map database 42 of the location estimation unit 4. The map data may be acquired from an external server.

Then, at S204, the HMI-side processing unit 31 outputs the above-mentioned display request to the millimeter-wave radar sensor 2. The display request is output at S204 in response to a determination that the type of the user attempting to view the certification information is a professional user being made at S202. Therefore, the display request output at S204 includes, as user information, information indicating that the type of user attempting to view the certification information has been determined to be a professional user.

In addition, information indicating the country identified at S203 is included in the display request as country information. For example, if the country corresponding to the current location information of the vehicle is determined to be Country A, the display request output at S204 is a request for performing a process to display the certification information on the display unit 32 in the display mode for the professional users and pursuant to the laws and regulations of Country A. Then, in the HMI-side processing unit 31, the routine proceeds to S207.

On the other hand, if the HMI-side processing unit 31 determines at S202 that no password has been entered by the user via the operating unit 5, the routine proceeds to S205.

At S205, the HMI-side processing unit 31 identifies the country corresponding to the current location of the vehicle, as in S203.

Then, at S206, the HMI-side processing unit 31 outputs the display request to the millimeter-wave radar sensor 2, as in S204. The display request is output at S206 in response to a determination that the type of the user attempting to view the certification information is a general user being made at S202.

Therefore, the display request output at S206 includes, as user information, information indicating that the type of the user attempting to view the certification information has been determined to be a general user. In addition, information indicating the country identified at S205 is included in the display request as country information. Then, in the HMI-side processing unit 31, the routine proceeds to S207.

At S207, the HMI-side processing unit 31 receives image information from the millimeter-wave radar sensor 2. Specifically, the image information to be received is display information or error information, output by the sensor-side processing unit 21 of the millimeter-wave radar sensor 2 according to the display request.

Then, at S208, the HMI-side processing unit 31 displays the image representing the image information input at S207 on the display unit 32. In the case where the input image information is display information, the certification information is displayed on the display unit 32 in the display mode corresponding to the display request. On the other hand, in the case where the input image information is error information, an error message or confirmation message is displayed on the display unit 32. The HMI-side processing unit 31 then terminates the request determination process illustrated in FIG. 5.

That is, in the case where the millimeter-wave radar sensor 2 is in the on-board state, the certification information or error message is displayed on the display unit 32 by performing the request determination process illustrated in FIG. 5.

On the other hand, in the case where the millimeter-wave radar sensor 2 is in the stand-alone state and communicably connected to the external display device 9, the image representing the image information input to the external display device 9 from the millimeter-wave radar sensor 2 is displayed on the external display device 9.

When the input image information is display information, the certification information is displayed on the external display device 9 in the display mode for the professional users and pursuant to the laws and regulations of the country of use entered by the user. On the other hand, when the input image information is error information, an error message or confirmation message is displayed on the external display device 9.

### 4. Advantages

The present embodiment described in detail above can provide the following advantages.

(4a) The millimeter-wave radar sensor 2 performs the certification information display process to display the certification information on the display unit 32 as an on-board display device, using the display information stored in the storage unit 23. According to this configuration, since the certification information of the millimeter-wave radar sensor 2 is displayed on the display unit 32, the display requirement for the certification information can be met without having to secure a display space for the certification information on the body of the millimeter-wave radar sensor 2.

(4b) The millimeter-wave radar sensor 2 determines whether the user attempting to view the certification information is a general user or a professional user. The storage unit 23 stores display information for displaying the certification information on the display device in the display mode for general users and display information for displaying the certification information on the display device in the display mode for professional users.

When the millimeter-wave radar sensor 2 determines that the user is a general user, the millimeter-wave radar sensor 2 performs the process for displaying the certification information in the display mode for general users. When the millimeter-wave radar sensor 2 determines that the user is a professional user, the millimeter-wave radar sensor 2 performs the process for displaying the certification information in the display mode for professional users. According to this configuration, the user is allowed to view the certification information in the display mode suitable for that person.

(4c) In the display mode for professional users, supplementary information for professional users on the certification information, which is not displayed in the display mode for general users, is displayed. According to this configuration, the user is allowed to view the certification information in the display mode that is suitable for the purpose of viewing the certification information.

That is, while the general-user's purpose is to confirm that the millimeter-wave radar sensor 2 is a product that conforms to the technical standard specified by the laws and regulations, the professional-user's purpose is, additionally, to determine that the certification information is legally displayed.

Therefore, general users are expected to feel annoying when information other than the certification information is displayed. On the other hand, professional users are expected to desire that supplementary information be displayed along with the certification information.

In this regard, according to the present embodiment, since supplementary information that is not displayed in the display mode for general users is displayed in the display mode for professional users, the user is allowed to view the certification information in the display mode suitable for his/her purpose of viewing the certification information.

(4d) In the case where the millimeter-wave radar sensor 2 is in the stand-alone state and communicably connected to the external display device 9, the millimeter-wave radar sensor 2 performs the certification display process to display the certification information on the external display device 9 in the display mode for professional users. According to such a configuration, a user is allowed to view the certification information in the display mode suitable for the purpose of viewing the certification information, regardless of the presence or absence of a configuration where an indication of the type of user is entered by the user.

That is, since the millimeter-wave radar sensor 2 is an on-board device, it is assumed that the millimeter-wave radar sensor 2 is normally in the on-board state. Thus, it is assumed that users who view the certification information of the millimeter-wave radar sensor 2 usually view the certification information while the millimeter-wave radar sensor 2 is in the on-board state.

On the other hand, in the case where the millimeter-wave radar sensor 2 is in the stand-alone state and connected to the external display device 9, a special situation is assumed where the certification information is displayed while the millimeter-wave radar sensor 2 is not mounted to the vehicle. Thus, it is assumed that a user attempting to view the certification information while the millimeter-wave radar sensor 2 is in the stand-alone state is not a general user, such as a vehicle occupant, but a professional user.

It is also assumed that in the stand-alone state where the millimeter-wave radar sensor 2 may be connected only to an external display device, there is no configuration where an indication of the type of user is entered by the user, unlike in the on-board state where an indication of the type of user is entered by the user.

In the present embodiment, in the case where the millimeter-wave radar sensor 2 is in the stand-alone state and communicably connected to the external display device 9, the certification information is displayed in the display mode for professional users even if no indication of the type of user is entered. Therefore, a user is allowed to view the certification information in the display mode suitable for the purpose of viewing the certification information, regardless of the presence or absence of a configuration where an indication of the type of user is entered by the user.

(4e) The storage unit 23 stores display information for displaying certification information in the display mode pursuant to the laws and regulations of each of a plurality of countries. The millimeter-wave radar sensor 2 determines the country of use and performs the process for displaying the certification information in the display mode pursuant to the laws and regulations of the country of use determined by the millimeter-wave radar sensor 2. Even if the millimeter-wave radar sensor 2 is used in more than one country, such a configuration allows the display requirements based on the laws and regulations of the country of use to be met.

(4f) In the storage unit 23, the same display information is stored redundantly in three memories 231. The millimeter-wave radar sensor 2 determines the presence or absence of an abnormality in the display information by comparing the redundantly stored identical display information with each other. Such a configuration enables detection of an abnormality in the display information to be detected with a simplified configuration.

(4g) In the case where the millimeter-wave radar sensor 2 determines that the display software has been tampered with, the millimeter-wave radar sensor 2 performs error handling. Such a configuration can prevent certification information from being displayed abnormally.

(4h) In the on-board system 1 of the present embodiment, the HMI processing device 3 receives an indication, entered by a user, of whether the user is a general user or a professional user, and requests the millimeter-wave radar sensor 2 to perform the process for displaying certification information in the display mode in accordance with the indication entered by the user. Based on the request, the millimeter-wave radar sensor 2 determines whether the user attempting to view the certification information is a general user or a professional user.

Such a configuration allows the user to select a display mode suitable for that person with respect to display of the certification information.

(4i) In the on-board system 1 of the present embodiment, the HMI processing device 3 identifies the country corresponding to the current location of the vehicle and requests the millimeter-wave radar sensor 2 to perform the process for displaying certification information in the display mode pursuant to the laws and regulations of the country so identified. The millimeter-wave radar sensor 2 determines the country of use based on the request.

Such a configuration allows the user to view the certification information in the display mode pursuant to the laws and regulations of the country of use, without having to enter the country of use.

In the present embodiment, the millimeter-wave radar sensor 2 corresponds to an on-board device, the HMI side processing unit 31 corresponds to a display control device, and the display unit 32 corresponds to an on-board display device.

Referring to FIG. 1B illustrating a functional block diagram of the sensor-side processing unit 21 of the millimeter-wave radar sensor 2, the sensor-side processing unit 21 includes an abnormality detection unit 211, a user determination unit 212, a country determination unit 213, an abnormality determination unit 214, and a display processing unit 215. The abnormality detection unit 211 is configured to perform the process step S101. The user determination unit 212 is configured to perform the process steps S104 and S106. The country determination unit 213 is configured to perform the process steps S105 and S107. The abnormality determination unit 214 is configured to perform the process step S109. The display processing unit 215 is confined to perform the process steps S110, S113, and S115. The functions of these units 211 to 215 may be implemented by the CPU executing the program stored in the non-transitory tangible storage medium, such as the ROM, as described above regarding the sensor-side processing unit 21.

Referring to FIG. 1C illustrating a functional block diagram of the HMI-side processing unit 31 of the HMI processing device 3 according the present embodiment, the HMI-side processing unit 31 includes an input unit 311, an identification unit 312, and a request unit 313. The input unit 311 is configured to perform the process step S202. The identification unit 312 is configured to perform the process steps S203 and S205. The request unit 313 is configured to perform the process steps S204 and S206. The functions of these units 311 to 313 may be implemented by the CPU executing the program stored in the non-transitory tangible storage medium, such as the ROM, as described above regarding the HMI-side processing unit 31.

### 5. Other Embodiments

While the specific embodiment of the present disclosure has been described above, the present disclosure is not limited to the above-described embodiment, and may incorporate various modifications.

(5a) In the above embodiment, the configuration in which the display information is image information representing the entire display image has been exemplified. Alternatively, the display information may also be comprised of a plurality of pieces of image information that represent respective portions of the display image. For example, the display information may be comprised of a piece of image information representing the common portion of the display image in the display mode for general users and the display image in the display mode for professional users, and pieces of image information representing different portions.

In the example of Country X described above, the display image in the display mode for general users represents certification information, and the display image in the display mode for professional users represents certification information plus supplementary information. In this case, the common portion is the portion that represents the certification information, and the different portion is a portion that represents the supplementary information.

That is, in the example of Country X, the piece of image information representing the common portion is used for displaying the display image in the display mode for general users, and the piece of image information representing the common portion and the piece of image information representing the difference portion are used for displaying the display image in the display mode for professional users.

According to such a configuration, the data volume of the display information stored in storage unit 23 can be reduced because overlapping portions of contents of the display information are reduced as compared to the case where the display information is the image information representing the entire display image.

(5b) In the above embodiment, the configuration in which the display information is image information has been exemplified. Alternatively, the display information may also be information for generating image information. For example, the display information may be text information that represents characters. Specifically, for example, text information representing explanatory text, such as supplementary information, may be stored as display information, and image information representing the explanatory text may be generated based on the display information.

(5c) The method of determining the type of user is not limited to the determination method exemplified in the above embodiment. For example, the type of user may be determined based on the determination of whether the millimeter-wave radar sensor 2 is in the on-board state.

Specifically, for example, the user may be a general user when the millimeter-wave radar sensor 2 is in the on-board state, and the user may be a professional user when the millimeter-wave radar sensor 2 is in the stand-alone state. For example, even when the millimeter-wave radar sensor 2 is in the stand-alone state, the type of user may be determined based on an indication of the type of user entered by the user.

(5d) The method of determining the country of use is not limited to the determination method exemplified in the above embodiment. For example, the country of use may be determined based on an input by the user even when the millimeter-wave radar sensor 2 is in the on-board state. For example, even when the millimeter-wave radar sensor 2 is in the stand-alone state, the country of use may be determined based on the current location estimated using the GPS receiver or the like.

(5e) The display modes for displaying the certification information are not limited to the display modes exemplified in the above embodiment. For example, the number of types of display modes in accordance with the types of users is not limited to two (i.e., the display mode for general users and the display mode for professional users). Alternatively, there may be three or more types of display modes, or there may be one type of display mode that is not distinguished by the types of users.

For example, there may be one type of display mode pursuant to the laws and regulations of a plurality of countries, not limited to a plurality of types of display modes. In cases where countries of use are limited to a plurality of countries with common requirements for displaying certification information, one type of display mode may be used pursuant to the laws and regulations of the plurality of countries.

For example, in cases where the country of use is limited to one country, one type of display mode may be available pursuant to the laws and regulations of that one country. In these cases where one type of display information is available, the country of use does not have to be determined.

(5f) In the above embodiment, the configuration in which the same display information is stored redundantly in three memories 231 has been exemplified. Alternatively, the same display information is stored redundantly in three areas in one memory 231.

The number of pieces of identical display information stored redundantly is not limited to three. In a case where four or more pieces of identical display information are stored redundantly, as in the above embodiment, a process of overwriting the remaining display information with the display information whose contents are likely to remain unchanged. Specifically, in a case where the display information with the highest number of mutual matches is identified as being one piece of display information, this piece of display information may be identified as the display information whose contents are likely to remain unchanged.

Alternatively, the number of pieces of display information that match each other being greater than or equal to a predefined percentage of the total number of pieces of display information stored redundantly may be included in the condition for identifying display information whose contents are likely to remain unchanged. For example, the number of pieces of display information that match each other being greater than half the total number of pieces of display information stored redundantly may be included in the condition for identifying display information whose contents are likely to remain unchanged.

Alternatively, for example, there being only one piece of display information that does not match the other pieces of display information, i.e., the remaining number of pieces of display information, excluding one piece, matches each other may be included in the condition for identifying display information whose contents are likely to remain unchanged. In a case where the display information whose contents are likely to have changed is not identified, error handling may be performed.

(5g) In the above embodiment, when at least one of the plurality of pieces of display information stored redundantly does not match the other pieces of display information stored redundantly, the display information with the greatest number of mutual matches is identified as the display information whose contents are likely to remain unchanged. The configuration in which the remaining display information other than the display information with the greatest number of mutual matches is overwritten with the identified display information has been exemplified. However, the overwriting process is not limited to such a configuration.

For example, master display information, which is stored with higher reliability than other display information, may be prepared, and the display information that does not match the master display information may be overwritten with the master display information. Alternatively, for example, the overwriting process may not be performed, and error handling may be performed whenever at least one of the plurality of pieces of display information does not match the other pieces of display information.

(5h) In the above embodiment, the configuration has been exemplified in which whether the display software has been tampered with is detected based on the hash value of the display software. The method of detecting whether the display software has been tampered with is not limited to such a configuration.

(5i) In the above example, the configuration has been exemplified in which a confirmation message is displayed instead of certification information when it is determined that the display software has been tampered with. Alternatively, for example, the configuration may be such that a confirmation message is displayed together with the certification information.

(5j) In the above embodiment, the configuration has been exemplified in which error handling for abnormalities in display information is different in content from error handling for abnormalities in display software. Alternatively, they may be the same.

(5k) In the above embodiment, the configuration has been exemplified in which software tampering is detected as a software abnormality. Alternatively or additionally to software tampering, a configuration may be such that software abnormalities other than software tampering are detected.

(5l) In the above embodiment, the push button installed on the steering wheel of the vehicle is exemplified as the operating unit 5. The operating unit 5 is not limited to such a push button. For example, in a configuration where a display device equipped with a touch panel is used as the on-board display device, this touch panel may be used as the operating unit 5.

(5m) In the above embodiment, a display capable of displaying map images for navigation or the like has been exemplified as the on-board display device. The on-board display device is not limited to such a display. Alternatively, for example, any other display device mounted to the vehicle, such as a meter display or a head-up display, may be used as the on-board display device.

(5n) In the above embodiment, a general-purpose display device is exemplified as the external display device 9. Alternatively, the external display device 9 may be, for example, a specific-purpose display device for displaying certification information.

(5o) In the above embodiment, the configuration in which the millimeter-wave radar sensor 2 is powered by the in-vehicle battery or the external display device 9 has been exemplified. However, the power source supplying power to the millimeter-wave radar sensor 2 is not limited to any of the in-vehicle battery and the external display device 9.

(5p) In the above embodiment, the millimeter-wave radar sensor 2 is wired to the external device. Alternatively, the millimeter-wave radar sensor 2 may be wirelessly connected to the external device.

(5q) In the above embodiment, the millimeter-wave radar sensor 2 has been exemplified as the on-board device that displays certification information. The on-board device is not limited to such a millimeter-wave radar sensor. For example, the on-board device may be any other on-board device subject to the radiocommunications law. Alternatively, for example, the on-board device may be an on-board device that is subject to laws and regulations other than the radiocommunications law that require the certification information to be displayed.

(5r) The functions of a single component may be distributed to a plurality of components, or the functions of a plurality of components may be consolidated into a single component. At least part of the configuration of the above embodiments may be removed. At least part of the configuration of one of the above embodiments may be replaced with or added to the configuration of another one of the above embodiments.

What is claimed is:

1. An on-board device for a vehicle, comprising:
a storage unit configured to store display information that is information for displaying certification information required to be displayed pursuant to laws and regulations on a display device; and
a display processing unit configured to perform a process for displaying the certification information on an on-board display device that is the display device on-board the vehicle, using the display information stored in the storage unit.

2. The on-board device according to claim 1, further comprising:
a user determination unit configured to determine whether a user attempting to view the certification information is a general user or a professional user, wherein
the storage unit is configured to store, as the display information, display information for displaying the certification information in a display mode for general users and information for displaying the certification information in a display mode for professional users, and
the display processing unit is configured to, in response to the user determination unit determining that the user is a general user, perform a process for displaying the certification information in the display mode for general users, and in response to the user determination unit determining that the user is a professional user, perform a process for displaying the certification information in the display mode for professional users.

3. The on-board device according to claim 2, wherein
in the display mode for professional users, supplementary information on the certification information for professional users, which is not displayed in the display mode for general users, is displayed additionally.

4. The on-board device according to claim 2, wherein
the user determination unit is configured to, upon the on-board device being communicably connected to an external display device with the on-board device not on-board the vehicle, determine that a user attempting to view the certification information is a professional user.

5. The on-board device according to claim 1, further comprising:
a country determination unit configured to determine a country in which the on-board device is used, wherein
the storage unit is configured to store, as the display information, information for displaying the certification information in a display mode pursuant to the laws and regulations of each of a plurality of countries, and
the display processing unit is configured to perform a process for displaying the certification information in the display mode pursuant to the laws and regulations of the country determined by the country determination unit.

6. The on-board device according to claim 1, further comprising:
an abnormality determination unit configured to determine an abnormality in the display information stored in the storage unit, wherein
the storage unit is configured to redundantly store same display information in a plurality of areas, and
the abnormality determination unit is configured to determine an abnormality in the display information by comparing the same display information stored redundantly in the plurality of areas.

7. The on-board device according to claim 1, further comprising:
an abnormality detection unit configured to detect an abnormality in software that implements the process for displaying the certification information on the on-board display device, wherein
the display processing unit is configured to, in response to the abnormality detection unit detecting an abnormality in the software, perform a process for displaying, on the on-board display device, information indicating presence of an abnormality in the software.

8. The on-board device according to claim 1, wherein the laws and regulations comprise a radiocommunications law.

9. The on-board device according to claim 1, further comprising a millimeter-wave radar.

10. An on-board system for a vehicle, comprising:
an on-board device configured to be used on-board the vehicle, comprising:
a storage unit configured to store display information that is information for displaying certification information required to be displayed pursuant to laws and regulations on a display device;
a display processing unit configured to perform a process for displaying the certification information on an on-board display device that is the display device on-board the vehicle, using the display information stored in the storage unit; and
a user determination unit configured to determine whether a user attempting to view the certification information is a general user or a professional user; and
a display control device configured to be used on-board the vehicle, comprising:
an input unit configured to receive, from the user, an indication of whether the user is a general user or a professional user; and
a request unit configured to request the on-board device to perform a process for displaying the certification information on the on-board display device in a display mode according to the indication received by the input unit,
wherein
the storage unit is configured to store, as the display information, display information for displaying the certification information in a display mode for general users and information for displaying the certification information in a display mode for professional users,
the display processing unit is configured to, in response to the user determination unit determining that the user is a general user, perform a process for displaying the certification information in the display mode for general users, and in response to the user determination unit determining that the user is a professional user, perform a process for displaying the certification information in the display mode for professional users, and
the user determination unit is configured to determine, based on a request from the request unit, whether the user attempting to view the certification information is a general user or a professional user.

11. An on-board system for a vehicle, comprising:
an on-board device configured to be used on-board the vehicle, comprising:
a storage unit configured to store display information that is information for displaying certification information required to be displayed pursuant to laws and regulations on a display device; and
a display processing unit configured to perform a process for displaying the certification information on an on-board display device that is the display device on-board the vehicle, using the display information stored in the storage unit; and
a country determination unit configured to determine a country in which the on-board device is used; and
a display control device configured to be used on-board the vehicle, comprising:
an identification unit configured to identify a country corresponding to a current location of the vehicle; and
a request unit configured to request the on-board device to perform a process for displaying the certification information on the on-board display device in a display mode pursuant to the laws and regulations of the country identified by the identification unit, wherein
the storage unit is configured to store, as the display information, information for displaying the certification information in a display mode pursuant to the laws and regulations of each of a plurality of countries, and
the display processing unit is configured to perform a process for displaying the certification information in the display mode pursuant to the laws and regulations of the country determined by the country determination unit, and
the country determination unit is configured to determine a country in which the on-board device is used based on a request from the request unit.
